(19) United States
(12) Patent Application Publication
(10) Pub. No.: US 2005/0246625 A1
(43) Pub. Date: Nov. 3, 2005

(54) Non-linear example ordering with cached lexicon and optional detail-on-demand in digital annotation

(75) Inventors: Giridharan Iyengar, Mahopac, NY (US); Chalapathy V. Neti, Yorktown Heights, NY (US); Harriet J. Nock, Elmsford, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/836,843

(22) Filed: Apr. 30, 2004

(51) Int. Cl. G06F 17/24

(52) U.S. Cl. 715/512

(57) ABSTRACT

Methods and arrangements for annotating digital input. Digital media input is accepted, with the input being arranged in frames, while in annotating at least one of the following are performed: the presentation of frames for annotation in non-linear fashion; and the employment of a cached annotation lexicon for applying labels to frames.

### FIELD OF THE INVENTION

The present invention relates to the manual or semi-automatic annotation of digital objects derived from digital media, including (but not restricted to) digital objects derived from digital video (e.g. video frames, speech and non-speech audio segments, closed captioning) or digital images.

### BACKGROUND OF THE INVENTION

Annotation, in the present context, generally implies the association of labels with one or more digital objects. Specific examples include:
(1) semantic concept labels, such as “face” or “outdoors”, attached to single images or video frames; the association may be specified from labels onto the full image (“global” association) or image-region (“regional” association);
(2) audio labels such as “speaker identity”, sound type such as “music” and transcriptions of spoken words; association may be specified from labels onto the full audio soundtrack (“global”) or on shorter units such as sentences or otherwise-defined sub-stretches within the full soundtrack.

Generally, the digital media collection to be annotated can be of any size; all digital objects derived from the collection (e.g., images, video frames, audio sequences) are potential candidates for annotation but the subset selected may vary with the application. The precise set of digital objects to be annotated may be either (a) all digital objects in the collection or (b) a subset specified by the user. E.g. when annotating video frames, the set of frames to be annotated may be all video frames in the collection or a subset thereof (e.g., keyframes).

The set of labels that can be used in annotation is normally referred to as the “lexicon”; the contents of the lexicon can be fixed in advance or user-controllable. The result of annotation is a mapping between entire digital objects (e.g. video frames) or parts thereof (e.g. video frame regions) and labels; this mapping can be represented using e.g. MPEG7-XML.

Once generated, the applications of such annotations include multimedia indexing for search (e.g. digital libraries) or as input to statistical model training. The quality of annotations is critical to the results produced in both of these applications; further, since the volumes of data used by both are potentially very large, it is of interest to reduce the time taken to produce annotations as much as possible. In this context, a need has been recognized in connection with providing user interface design techniques for use in a system supporting manual or semi-automatic annotation of digital media for the purpose of improving the speed and consistency of annotation performance.

Among the known user interfaces for systems for annotating digital objects derived from digital media are the current IBM MPEG7 Annotation Tool (see www.alphaworks.ibm.com), IBM Multimodal Annotation Tool (see www.alphaworks.ibm.com). These tools support actions such as annotating keyframes or audio derived from digital video. With the type of user interfaces for annotation contemplated in connection with these tools, the sequence of keyframes or audio to be annotated is presented in temporal order, and a large lexicon is maintained in scrollable windows. These interfaces have the following problems, described here in the context of keyframe annotation but which are generally applicable to the annotation of digital objects, however:
Problem (a): Frames which are “similar” (in the sense of requiring similar labels) may occur in temporally disjoint frames (the “digital objects”) within the video (the “digital media”). However, users must view all frames in temporal order even if they choose to annotate only a subset and thus “visually similar” frames may not be viewed sequentially. This results in problems such as inconsistency between labels assigned to “similar” frames that are disjoint in time.
Problem (b): For any practical application the lexicon is likely to be large, but these tools display the list of lexicon items via scrollable windows. Navigating (e.g. scrolling) through a large lexicon is time-consuming and slows down annotation.

Accordingly, a need has been recognized in particular in connection with solving the above problems.

In other known arrangements, U.S. Pat. No. 6,332,144 (“Techniques for Annotating Media”) addresses the problem of annotating media streams but does not consider user interface issues. U.S. Pat. No. 5,600,775 (“Method and apparatus for annotating full motion video and other indexed data structures”) addresses the problem of annotating video and constructing data structures but does not consider user interface issues as discussed above. Copending and commonly assigned U.S. patent application Ser. No. 10/315,334, filed Dec. 10, 2002, addresses apparatus and methods for the semantic representation and retrieval of multimedia content but does not consider user interface issues as discussed above.

In Girgensohn, A., “Simplifying the Authoring of Linear and Interactive Videos”, (discussed in a 2003 talk at IBM TJ Watson Research Center given by Andreas Girgensohn, FX Palo Alto Laboratory, Palo Alto, Calif., 2003; www.fxpal.com/people/andreasg) there are suggested detail-on-demand ideas for editing of video, but they do not apply the idea to the manual or semi-automatic annotation of digital objects.

### SUMMARY OF THE INVENTION

In accordance with at least one presently preferred embodiment of the present via a pair of techniques (a) and (b), as follows:
Technique (a): The user-refinable non-linear presentation of examples for annotation with user-controllable detail-on-demand to control the number of examples to be presented.
Technique (b): The use and display of a cached annotation lexicon.

In summary, one aspect of the invention provides an apparatus for annotating digital input, the apparatus comprising: an arrangement for accepting digital media input, the input being arranged in frames; and an arrangement for annotating the frames; the annotating arrangement being adapted to perform at least one of the following: present frames for annotation in non-linear fashion; and employ a cached annotation lexicon for applying labels to frames.

Another aspect of the invention provides a method of annotating digital input, the method comprising the steps of: accepting digital media input, the input being arranged in frames; and annotating the frames; the annotating step comprising at least one of the following: presenting frames for annotation in non-linear fashion; and employing a cached annotation lexicon for applying labels to frames.

Furthermore, an additional aspect of the invention provides a program storage device readable by machine, tangibly embodying a program of instructions executable by the machine to perform method steps for annotating digital input, the method comprising the steps of: accepting digital media input, the input being arranged in frames; and annotating the frames; the annotating step comprising at least one of the following: presenting frames for annotation in non-linear fashion; and employing a cached annotation lexicon for applying labels to frames.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIGS. 1 and 2 are schematic illustrations of annotation techniques.

### DESCRIPTION OF THE PREFERRED EMBODIMENTS

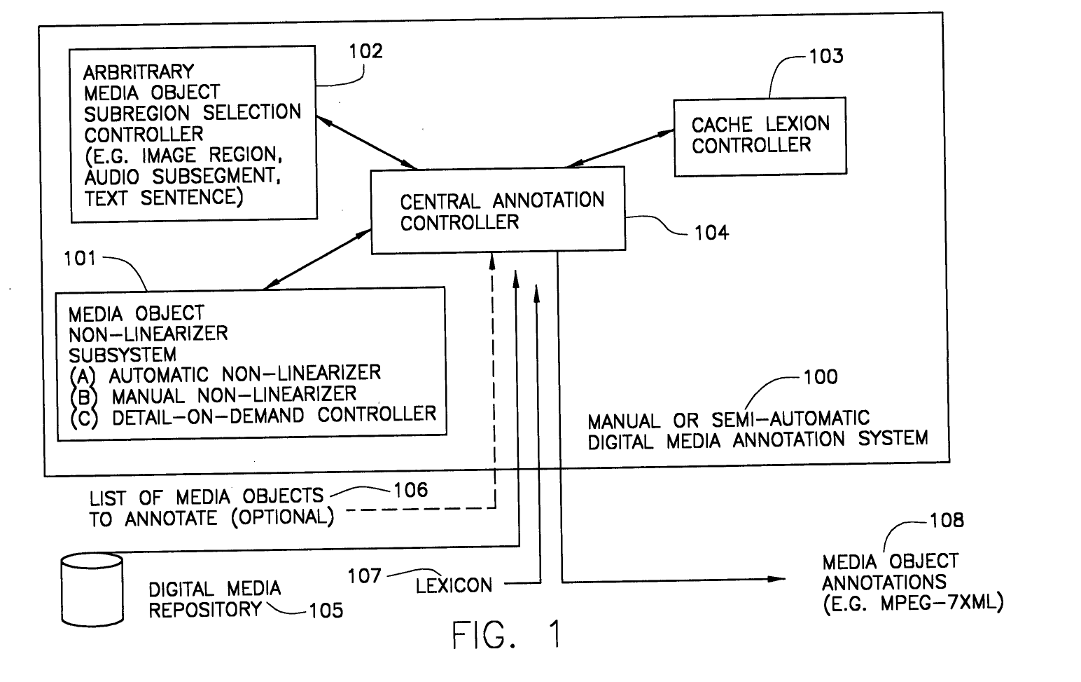

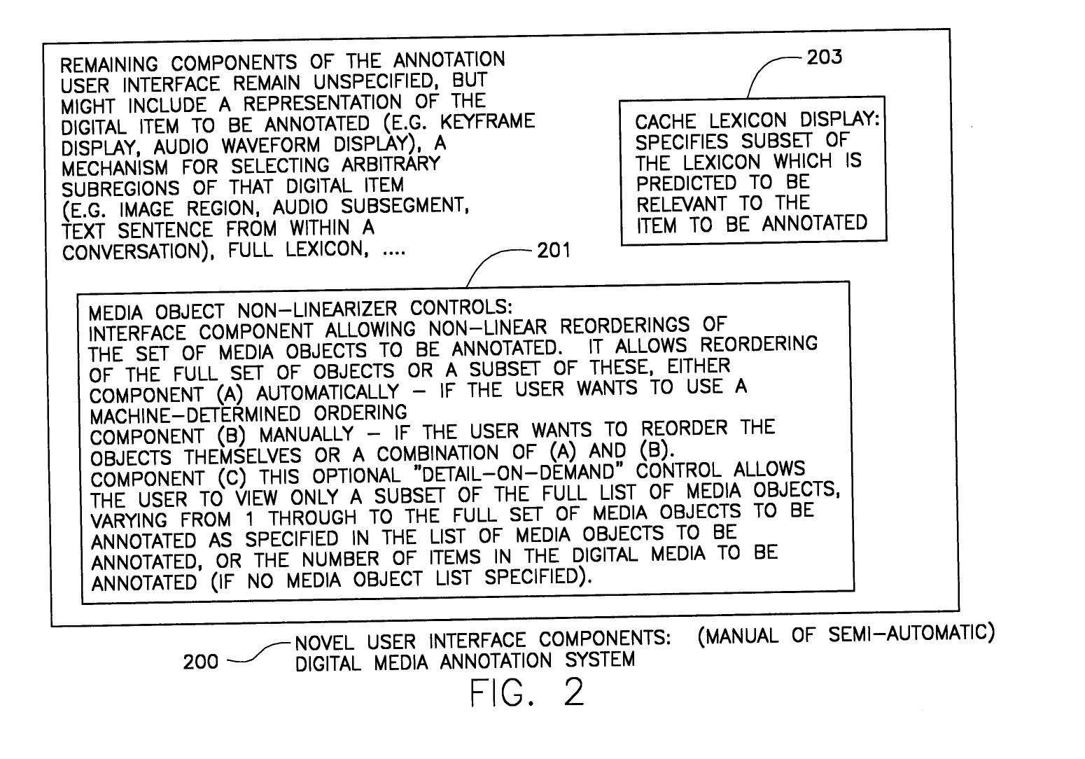

FIG. 1 is a schematic illustration of an annotation system 100 and associated inputs as contemplated in accordance with at least one presently preferred embodiment of the present invention. Input may typically include any or all of: media objects from a digital media repository 105, an optional list 106 specifying a subset of the media objects in the repository which should be annotated, and a base lexicon 107; these inputs feed into a central annotation controller 104. This “hub” component preferably is configured to provide input to any of several other controllers, whose use and functionality will be appreciated more fully from the discussion herebelow: an arbitrary region section controller 102, a frame non-linearizer subsystem 101 and a cache lexicon controller 103. Output from the central annotation controller 104 is indicated at 108 in the form of media object annotations in a representation such as MPEG7 XML. FIG. 2 is a schematic illustration of the novel components of a user interface 200 which supports interaction with the system shown in 100; the functionality of the proposed additional features of a cache lexicon display 201 and media object non-linearizer controls 202 will be made clearer below. FIGS. 1, 2 and their components are referred to further throughout the discussion herebelow.

In connection with technique (a), as outlined above, it is to be noted that the annotation of digital media has traditionally been performed in temporal collection order (e.g. entire videos, entire conversations). For example, for digital video keyframe annotation, annotation is performed on the level of frames whether keyframes or the full sequence of video frames. In known interfaces for supporting annotation of digital media (IBM MPEG7 Annotation Tool, IBM Multimodal Annotation Tool), this sequence is presented in temporal order. No attempt is made there to present digital objects to be annotated in an order which will assist in the speed of annotation. In contrast, there is broadly contemplated in accordance with an embodiment of the present invention the presentation of examples in a potentially non-linear (i.e. non-temporally ordered) fashion, with optional user reordering and detail-on-demand control during annotation.

Preferably, there is provided (as part of a general interface 200 for supporting user interaction with an annotation system such as 100) an additional set of controls supporting user interaction with the system in FIG. 1 to enable the non-linear reordering of arbitrary digital objects. The controls for realization of technique (a) are similar for different classes of digital objects, though examples are presented below for the examples of digital video frame annotation and audio annotation.

Interface component 201(a) allows the user to specify that frames should be non-linearly reordered automatically; this might preferably be a checkbox. This reordering is performed in component 101(a) of FIG. 1. E.g. For digital video frame annotation, one may first preferably use an automatic scheme to cluster frames into subsets using a similarity metric prior to presentation. This would occur within the media object non-linearizer subsystem in 101(a). Taking any subset as “starting point cluster 1”, one may rank all other subsets according to their similarity to this “starting point cluster 1”. Frames to be annotated are then presented to the user in decreasing rank order:

(cluster1frames)(cluster2frames)(cluster3frames) . . .

Should the user for some reason prefer to non-linearly reorder the frames themselves, they may instead use interface component 201(b) to manually reorder frames as required, supported by component 101(b) of FIG. (1). This might preferably be realized as a pop-up window allowing a reordering of objects.

A further interface control 201(c) allows the user to vary the number of items N to be annotated to vary between 1 through to the maximum possible number of objects; the algorithm in 101(c) supporting this component will preferably select the reduced set of N items to be distinct in visual feature space (such as RGB Histogram Space) but may be as simplistic as a random selection. This reduction or increase in detail has some similarities with the detail-on-demand approach of Girgensohn, supra.

The user proceeds with object annotation by stepping through the non-linear ordering resulting from any user interaction with component 201, or the default ordering if the user did not use component 201. To illustrate for the audio conversation transcription of a large collection of recordings, one may assume the presented examples comprise a set of conversations between N speakers falling into M broad accent groups (N being larger than M). The conversations are preferably segmented into sentences and then reordered into M subsets to be annotated by transcribers familiar with those accent groups. The reordering support in component 101 enables improved speed and accuracy of annotation (e.g. by supporting faster cut-and-paste or automatic propagation of labels between similar frames now located sequentially, or by using transcribers very familiar with the accent types), and to give users control over the number of examples they are willing to annotate without requiring them to step sequentially through all objects specified in the optional list 106 or the full set of objects as derived from the digital media.

An equally important result of supporting reordering of frames is to enhance the gains via Technique (b) (the use of a cached annotation lexicon). Preferably, a cached annotation lexicon will display labels used in recently annotated examples; this will improve speed if objects with similar labels are presented for annotation sequentially. It would complement a full lexicon listing all labels available.

To expand on this, typically, such a full lexicon is normally unmanageably large, wherein considerable time is needed for locating the labels to be associated with the full object or a subregion of the object as selected using component 102. For any given example, in accordance with one possible embodiment of a cached annotation lexicon, an additional cache lexicon display 203 may preferably be provided in the annotation interface of FIG. 2 displaying the labels used to annotate the previous media object or the set (or subset of) most common labels used in some number of recently annotated digital objects. The cache contents are controlled by the cache lexicon controller 103; the cache lexicon display 203 might preferably be a fixed or pop-up window in the interface but other realizations are also acceptable.

The advantage of Technique (b) is primarily related to its use in conjunction with Technique (a) and specifically component 101(a) of FIG. 1, since when examples are automatically non-linearly ordered due to (e.g.) example similarity, a useful cache can straightforwardly be maintained in an automatic fashion, since labels will change little across similar frames. Consistency of annotation of similar frames will therefore be improved.

It is to be understood that the present invention, in accordance with at least one presently preferred embodiment, includes an arrangement for accepting digital media input and an arrangement for annotating frames, which together may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. An apparatus for annotating digital input, said apparatus comprising:
an arrangement for accepting digital media input, the input being arranged in frames; and
an arrangement for annotating the frames;
said annotating arrangement being adapted to perform at least one of the following:
present frames for annotation in non-linear fashion; and
employ a cached annotation lexicon for applying labels to frames.

2. The apparatus according to claim 1, wherein:
said annotating arrangement is adapted to present frames for annotation in non-linear fashion.

3. The apparatus according to claim 2, wherein said annotating arrangement is further adapted to permit user-prompted alteration of the non-linear presentation of frames.

4. The apparatus according to claim 2, wherein said annotating arrangement is further adapted to permit user-prompted control of the number of frames presented.

5. The apparatus according to claim 2, wherein said annotating arrangement is adapted to cluster frames into subsets.

6. The apparatus according to claim 5, wherein said annotating arrangement is adapted to cluster frames into subsets via a similarity metric prior to presentation.

7. The apparatus according to claim 6, wherein said annotating arrangement comprises an arrangement for manually reordering clustered frames.

8. The apparatus according to claim 1, wherein said annotating arrangement is adapted to employ a cached annotation lexicon for applying labels to frames.

9. The apparatus according to claim 8, whereby sequential navigation through a large lexicon is avoided.

10. The apparatus according to claim 8, wherein the cached annotation lexicon is adapted to relate labels used in recent annotations.

11. The apparatus according to claim 1, wherein said annotating arrangement is adapted to perform both of the following:
present frames for annotation in non-linear fashion; and
employ a cached annotation lexicon for applying labels to frames.

12. The apparatus according to claim 1, wherein the digital media input comprises objects derived from at least one of: digital video and digital images.

13. A method of annotating digital input, said method comprising the steps of:
accepting digital media input, the input being arranged in frames; and
annotating the frames;
said annotating step comprising at least one of the following:
presenting frames for annotation in non-linear fashion; and
employing a cached annotation lexicon for applying labels to frames.

14. The method according to claim 13, wherein said annotating step comprises presenting frames for annotation in non-linear fashion.

15. The method according to claim 14, wherein said annotating step further comprises permitting user-prompted alteration of the non-linear presentation of frames.

16. The method according to claim 14, wherein said annotating step further comprises permitting user-prompted control of the number of frames presented.

17. The method according to claim 14, wherein said annotating step comprises clustering frames into subsets.

18. The method according to claim 17, wherein said clustering step comprises clustering frames into subsets via a similarity metric prior to presentation.

19. The method according to claim 18, wherein said annotating step comprises permitting the manual reordering of clustered frames.

20. The method according to claim 13, wherein said annotating step comprises employing a cached annotation lexicon for applying labels to frames.

21. The method according to claim 20, whereby sequential navigation through a large lexicon is avoided.

22. The method according to claim 20, wherein said employing step comprises relating labels used in recent annotations.

23. The method according to claim 13, wherein said annotating step comprises performing both of the following:
presenting frames for annotation in non-linear fashion; and
employing a cached annotation lexicon for applying labels to frames.

24. The method according to claim 13, wherein the digital media input comprises objects derived from at least one of: digital video and digital images.

25. A program storage device readable by machine, tangibly embodying a program of instructions executable by the machine to perform method steps for annotating digital input, said method comprising the steps of:
accepting digital media input, the input being arranged in frames; and
annotating the frames;
said annotating step comprising at least one of the following:
presenting frames for annotation in non-linear fashion; and
employing a cached annotation lexicon for applying labels to frames.
